(19) United States
(12) Patent Application Publication
(10) Pub. No.: US 2020/0080705 A1
(43) Pub. Date: Mar. 12, 2020

(54) MULTI FUNCTION LIGHTING DEVICE

(71) Applicant: Valeo North America, Inc., Troy, MI (US)

(72) Inventor: Charles Crespin, Seymour, IN (US)

(73) Assignee: Valeo North America, Inc., Troy, MI (US)

(21) Appl. No.: 16/129,030

(22) Filed: Sep. 12, 2018

(51) Int. Cl. F21V 13/04; G01N 21/956

(52) U.S. Cl. CPC F21V 13/04; G02B 27/145; G01N 21/95684

(57) ABSTRACT

The present disclosure relates to exterior lighting of an automotive vehicle. Specifically, the present disclosure describes a multi-function lighting assembly wherein a plurality of lighting functions can be provided from a single output surface. The multi-function lighting assembly can comprise an optical material having a first surface and a second surface wherein the second surface is a partially reflecting surface. According to an embodiment, a plurality of light rays from a first light source can be refracted through the partially reflecting surface and a plurality of light rays from a second light source can be reflected by the partially reflecting surface. In each case, the resulting reflected light ray or refracted light ray is directed along a visual axis of an observer, thereby providing more than one light function from a single output surface.

### FIELD OF THE DISCLOSURE

The present disclosure relates to exterior lighting of an automotive vehicle.

### DESCRIPTION OF THE RELATED ART

Exterior lighting devices of automotive vehicles traditionally comprise a light source, a reflecting surface, and a lens, wherein the reflecting surface is of a parabolic shape. When the lighting device is in an operative, or lit, state, light rays emitted from the light source are reflected by the reflecting surface and directed in a controlled direction through the lens.

Moreover, conventional lighting devices for exterior lighting of automotive vehicles often provide a single visual function or color when illuminated. Recently, users have requested the ability to provide two or more colors, from a single lighting device, when illuminated. In an example, this can be a single lighting device capable of presenting, at a first moment, a daytime running light, and at a second moment, a turn indicator, such that the provided light is perceived by an observer to originate from a single area.

Currently, if a user desires to present more than one color from a single functional area of a single lighting device, cumbersome light pipes or finely tuned dichroic minors may be required, each lacking, in cases, efficiency or form factor. Therefore, as users continue to request a variety of lighting functions with minimal form factor, it becomes important to develop a new approach to address these concerns.

The foregoing “Background” description is for the purpose of generally presenting the context of the disclosure. Work of the inventors, to the extent it is described in this background section, as well as aspects of the description which may not otherwise qualify as prior art at the time of filing, are neither expressly or impliedly admitted as prior art against the present invention.

### SUMMARY

The present disclosure relates to a multi-function lighting assembly of an automotive vehicle.

According to an embodiment, the present disclosure further relates to a multi-function lighting assembly, comprising an optical material including a first surface and a second surface, the second surface being a reflecting surface, and one or more light sources, wherein the one or more light sources are arranged such that a first one of the one or more light sources emits a first incident light ray towards the first surface of the optical material and a second one of the one or more light sources emits a second incident light ray towards the second surface of the optical material.

According to an embodiment, the present disclosure further relates to a multi-function lighting assembly, comprising an optical material including a first surface and a second surface, the second surface being a reflecting surface, a mirror, and one or more light sources, wherein the one or more light sources are arranged such that a first one of the one or more light sources emits a first incident light ray towards the first surface of the optical material and a second one of the one or more light sources emits a second incident light ray towards the second surface of the optical material, and wherein the mirror is arranged to reflect a portion of the emitted light from the one or more light sources, the reflected light being directed along an optical axis.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic of an exterior lighting device of an automotive vehicle, according to an exemplary embodiment of the present disclosure;

FIG. 2 is a schematic of a cross-sectional view of an optical material, according to an exemplary embodiment of the present disclosure;

FIG. 3A is a schematic of a cross-sectional view of a metallization process of an optical material, according to an exemplary embodiment of the present disclosure;

FIG. 3B is a flowchart describing a metallization of a surface of an optical material, according to an exemplary embodiment of the present disclosure;

FIG. 4 is a schematic of a cross-sectional view of a spatial arrangement of a light source and an optical material, according to an exemplary embodiment of the present disclosure;

FIG. 5 is a schematic of a cross-sectional view of an optical material and an ancillary reflective material, according to an exemplary embodiment of the present disclosure;

FIG. 6 is a flowchart describing an implementation of an optical material in an exterior lighting device of an automotive vehicle, according to an exemplary embodiment of the present disclosure; and

FIG. 7 is a hardware description of an optical control device, according to an exemplary embodiment of the present disclosure.

### DETAILED DESCRIPTION

The team is “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). Reference throughout this document to “one embodiment”, “certain embodiments”, “an embodiment”, “an 311 implementation”, “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

Moreover, it should be understood that the description of a ‘first incident light ray’, a ‘second incident light ray’, and the like, herein, is merely representative and indicative of a plurality of light rays emitted from a plurality of light sources, or, as described herein, a ‘first light source’ and a ‘second light source’, and, therefore, should be considered non-limiting.

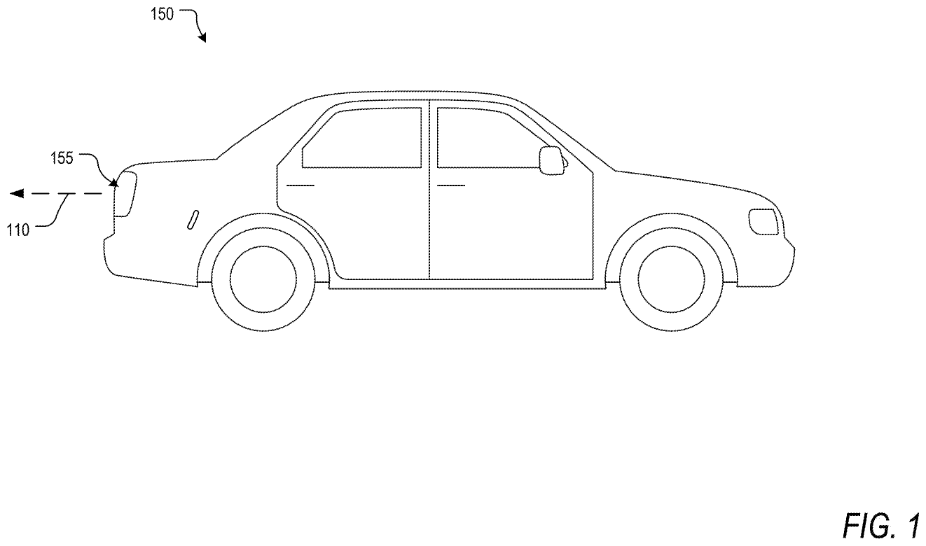

With reference to FIG. 1, the present disclosure is generally related to automotive lighting. More specifically, FIG. 1 illustrates an automotive vehicle 150 with a rear, exterior lighting device 155. It can be appreciated that the lighting device 155, or a direction indicator, in an example, is merely representative and can be one of a variety of lighting devices of the automotive vehicle including but not limited to dipped-beam lamps, main-beam lamps, front fog lamps, cornering lamps, daytime running lamps, parking lamps, direction indicators, tail lamps, and stop lamps. In an embodiment, the lighting device 155 can be mounted to the automotive vehicle 150 either vertically or horizontally, and other shapes of the lighting device 155 may be used as appropriate.

Recently, users have become interested in automotive lighting and/or signaling devices with advanced aesthetics. For example, it may be requested that a rear lighting device 155 appear amber during a turning operation in a first state, but appear white at all other times as, for example, a daytime running light. Achieving this aesthetic with the above described conventional lamp design may require the use of dichroic mirrors or cumbersome configurations of light guides, or light pipes, which may reduce efficiency of the system.

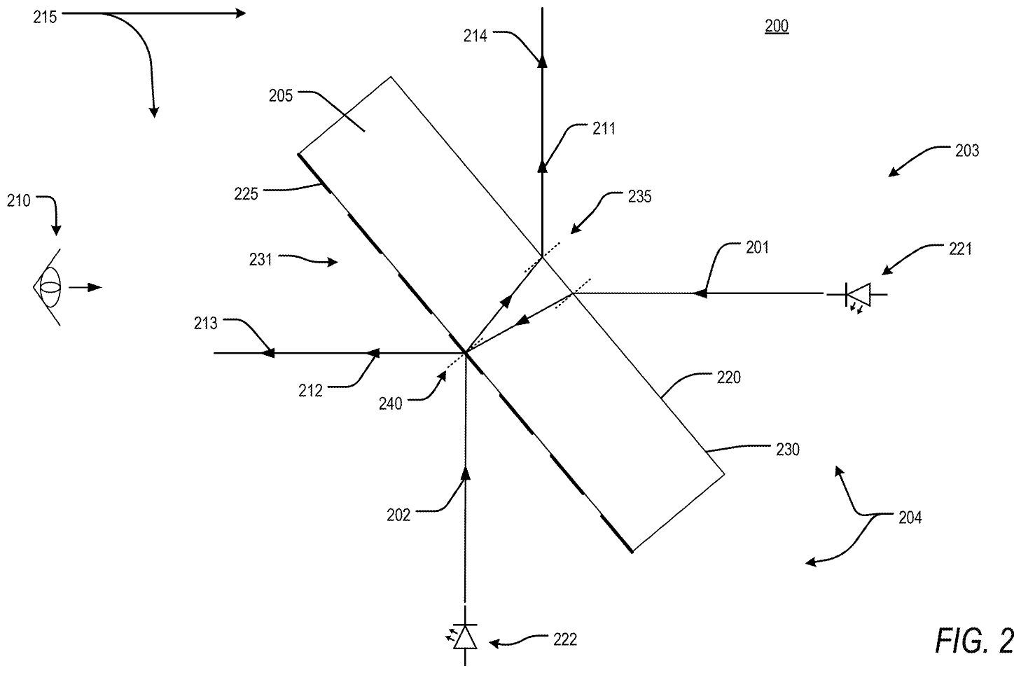

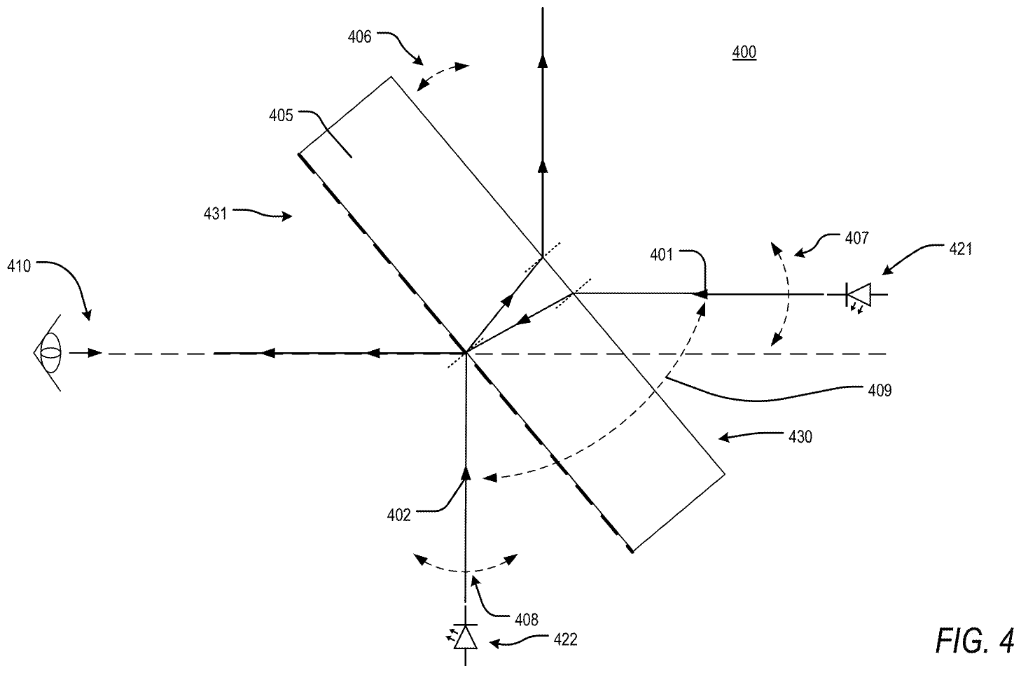

To this end, according to an embodiment of the present disclosure, FIG. 2, a cross-sectional view of a multi-function lighting assembly 200, describes the multi-function lighting assembly 200 including an optical material 205 having, a first surface 230 and a second surface 231. In an exemplary embodiment, the first surface 230 of the optical material 205 is a refracting surface 220 and the second surface 231 of the optical material 205 is a partially reflecting surface 225. The partially reflecting surface 225 can be achieved by a metallization process. The optical material 205 can be of a substantially rectangular shape and can be arranged such that a plurality of output light rays 215 refracted through the partially reflecting surface 225 of the optical material 205 are directed along an optical axis 210 of an observer. In an embodiment, the optical material 205 can be arranged such that an angle formed between an axis of the optical material 205 and one of a plurality of input light rays 204, or one of a plurality of incident light rays 203, is between 35° and 55°. In an example, the angle formed between the axis of the optical material 205 and the one of the plurality of incident light rays 203 is 45°, such that each of the plurality of output light rays 215 is directed along the optical axis 210 of the observer. The above-described angular relationships will be described in detail in FIG. 4.

According to an embodiment, the plurality of incident light rays 203 can include a first incident light ray 201 emitted from a first light source 221 and a second incident light ray 202 emitted from a second light source 222, it can be appreciated that each of the plurality of incident light rays 203 can be emitted from more than two light sources, the number of light sources being non-limiting and dependent upon factors discussed below including the refractive index of respective mediums and the optical material 205, in particular.

The first light source 221 can be selected from a group of one of a variety of light sources implementable in an automotive vehicle including a light-emitting diode (LED), an incandescent lamp, a high-intensity discharge lamp, a neon lamp tube, and the like, and can be configured to emit a color pre-determined by a user, the color selected from a group including white, red, yellow, blue, green, orange, purple, and the like. Similarly, the second light source 222 can be selected from the group of one of a variety of light sources implementable in an automotive vehicle including a LED, an incandescent lamp, a high-intensity discharge lamp, a neon lamp tube, and the like, and can be configured to emit a color pre-determined by a user, the color selected from a group including white, red, yellow, blue, green, orange, purple, and the like. In an example, the first light source 221 is an LED configured to emit an amber-colored light and the second light source 222 is an LED configured to emit a white light.

In order to provide a multi light function from a single area, or a dual light function, in an embodiment, the first light source 221 and the second light source 222 can be relatively arranged such that each of the plurality of output light rays 215 are directed along the same axis and from the same area following refraction or reflection by the optical material 205. To this end, an angle formed between the emitted light ray axes of each light source can be between 80° and 100′. In an example, the angle formed between the emitted light ray axis of the first light source 221 and the second light source 222 can be 90°.

According to an embodiment, as the first incident light ray 201 reaches the first surface 230, or refracting surface 220, of the optical material 205, the first incident light ray 201 can be refracted based upon a comparison of an angle formed between the first incident light ray 201 and the first surface 230 of the optical material 205, relative to a first normal axis 235, and a limiting angle of incidence defined by Snell-Descartes law, as would be understood by one of ordinary skill in the art. The limiting angle of incidence defines a limiting angle between a light ray in a first medium and a boundary of a second medium, wherein the two media have two, different refractive indexes. As a result, based upon the comparison of the angle formed between the first incident light ray 201 and the first surface 230 of the optical material 205, relative to the first normal axis 235, referred to as the angle of incidence, and the limiting angle of incidence, the first incident light ray 201 can be refracted or reflected. In an example, the angle of incidence of the first incident light ray 201 is sufficient that the first incident light ray 201 is refracted. Subsequently, the first incident light ray 201 is directed through the first surface 230 of the optical material 205 at a pre-determined angle such that it contacts the second surface 231 of the optical material 205 at an angle of incidence, relative to a second normal axis 240, sufficient for refraction. It can be appreciated that a similar understanding can be applied to each of a plurality of light rays described herein, mutatis mutandis. Moreover, it should be understood that the description of a single light ray, herein, is merely illustrative of a plurality of light rays emitted from a light source and, therefore, should be considered non-limiting.

According to an embodiment, upon refraction of the first incident light ray 201 through the first surface 230 of the optical material 205, the first incident light ray 201 may contact a region of the second surface 231 that is metallized. As described in detail below, the second surface 231 can be a metallized surface that approximates complete reflectivity or, alternatively, can be a metallized surface that is partially reflective, or, in other words, is less than 100% reflective. In the case of a plurality of light rays and with respect to the first incident light ray 201, in particular, this metallized region of the second surface 231 may create a partially reflecting surface 225 such that a portion of a plurality of refracted light rays from the first light source 221 can be reflected and a balance of the plurality of refracted light rays can be refracted through the second surface 231 of the optical material 205 and guided along the optical axis 210 of the observer. Once refracted through the second surface 231 of the optical material 205, the plurality of refracted light rays from the first light source 221 can be referred to as a first refracted light ray 212 as they are directed along the optical axis 210 of the observer. The reflected portion of the plurality of refracted light rays from the first light source 221, however, can again contact the first surface 230 of the optical material 205 wherein, based upon a comparison of an angle of incidence and the limiting angle of incidence, the light ray can be refracted through the boundary. In an example, reflected light rays from the first light source 221 can be refracted through the first surface 230 of the optical material 205 along a pre-determined path, the twice refracted light rays referred to as first reflected light rays 211.

Similarly, an emitted light ray from the second light source 222, or the second incident light ray 202, can contact the second surface 231 of the optical material 205. Following contact, the second incident light ray 202 can be refracted or reflected according to a relationship between an angle of incidence of the second incident light ray 202 with the second surface 231 of the optical material 205 and the limiting angle of incidence, in context of the second normal axis 240, wherein the relationship determines the fate of the second incident light ray 202. Moreover, the second incident light ray 202 may contact the region of the second surface 231 that is metallized. In the case of a plurality of light rays and with respect to the second incident light ray 202, in particular, this metallized region of the second surface 231 may create the partially reflecting surface 225 such that a portion of a plurality of second incident light rays 202 from the second light source 222 can be reflected along the optical axis 210 of the observer and a balance of the plurality of second incident light rays 202 can be refracted through the second surface 231 of the optical material 205. Reflected light rays from the second light source 222 can be referred to as second reflected light rays 213. The plurality of second incident light rays 202 refracted through the second surface 231 of the optical material 205, however, travel through the optical material and contact the first surface 230 of the optical material at an angle, relative to the first normal axis 235, sufficient for refraction. Once twice refracted, the plurality of second incident light rays 202 can be referred to as second refracted light rays 214.

According to an embodiment, similar to the first refracted light ray 212 and the second reflected light ray 213, the first reflected light ray 211 and the second refracted light ray 214 can be directed co-axially way from the optical material 205.

According to an embodiment, the first light source 221 and the second light source 222 can be controlled by a lighting control device configured to activate and deactivate the first light source 221 and the second light source 222 according to a user command or other command from the automotive vehicle.

It should be appreciated that, in another embodiment. the metallized surface, or, for example. partially reflecting surface 225, can be the first surface 230, wherein, immediately following emission, the first incident light ray 201 can be either reflected or refracted at the first surface 230 and the second incident light ray 202 can be refracted at the second surface 231.

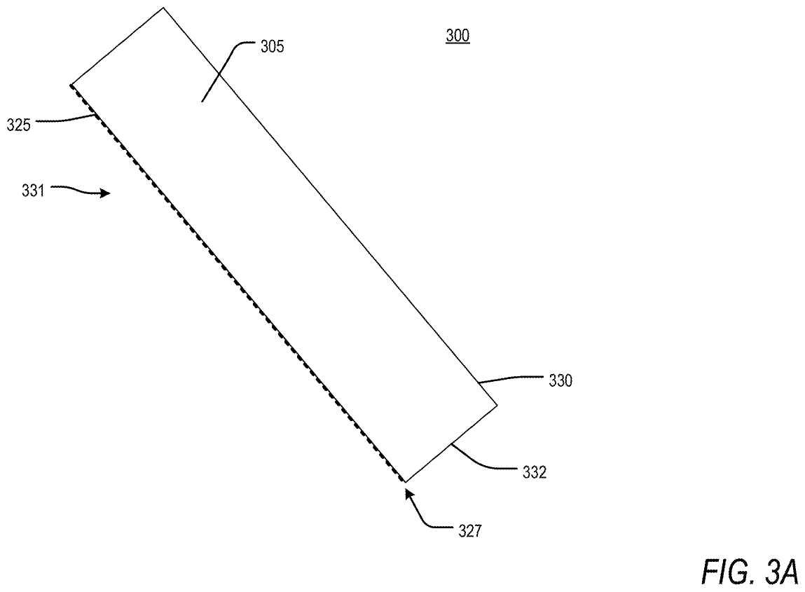

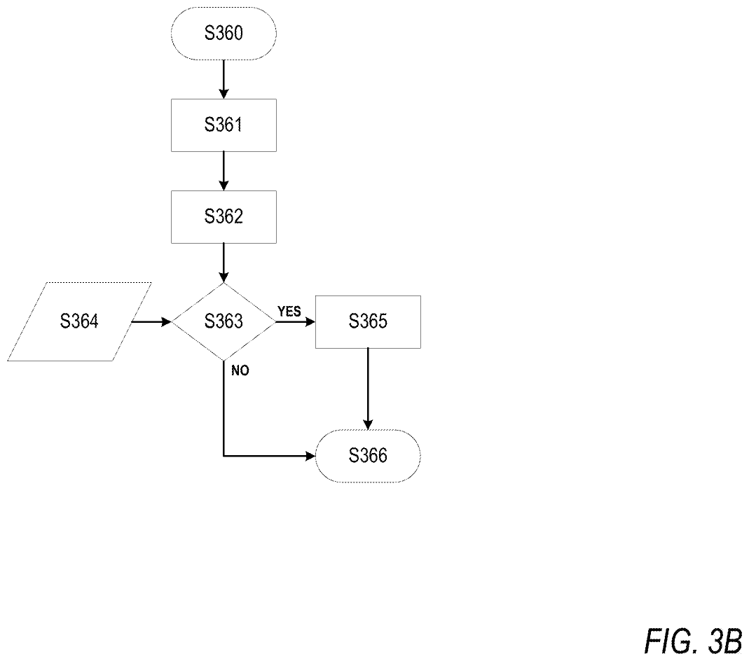

With reference to FIG. 3A, and in context of embodying the second surface of the optical material with dual function, a process of metallization is described. An optical material 305 can have a thickness 332, defined as a distance between a first surface 330 and a second surface 331, wherein the thickness 332 is determined such that a light ray refracted through the optical material 305 is directed to a specific location of an opposing surface of the optical material 305. In an example, the thickness 322 of the optical material 305 is between 2.5 mm and 3.5 mm. According to an embodiment, the optical material 305 can be fabricated from a material selected from a group including acrylics and polycarbonates, and, in particular, polycarbonate and poly(methyl methacrylate), via a method selected from a group including but not limited to injection molding, machining, and three-dimensional printing. A metallization can be applied to the second surface 331 of an optical material 305 such that the second surface 331 becomes an approximately completely reflecting surface or a partially reflecting surface 325, the optical material 305 being substantially rectangular in an example. In an embodiment, and as described below, the second surface 331 is the partially reflecting surface 325. It can be appreciated that the partially reflecting surface 325 can be the first surface 330, mutatis mutandis.

Generally, the partially reflecting surface 325 can be achieved via a method selected from a group including but not limited to physical vapor deposition including sputter coating, thermal physical vapor deposition, electron-beam physical vapor deposition, atomic layer deposition, chemical vapor deposition, arc and flame spraying, and electroplating. The partially reflecting surface 325 may comprise a material selected from a group including but not limited to aluminum, zinc, nickel, chromium, gold, palladium, germanium, copper, silver, tungsten, platinum, tantalum, and alloys thereof. Metallization of the partially reflecting surface 325 may be a metallization according to a desired reflectivity of the partially reflecting surface 325. In an embodiment, metallization may be controlled such that a percentage of deposition coverage or deposition thickness 327 may be pre-determined. In an exemplary embodiment, metallization may be controlled such that reflectivity of the partially reflecting surface 325 is between 1% and 100%. In an exemplary embodiment, metallization may be controlled such that reflectivity, of the partially reflecting surface 325 is between 40% and 60%. In an exemplary embodiment, metallization may be controlled such that reflectivity of the partially reflecting surface 325 is between 45% and 55%.

According to an embodiment, and in addition to controlling deposition parameters, the partially reflective surface described above can be achieved by preparing the second surface 331 prior to metallization. In an example, by masking a portion of the second surface 331, or by similar process, an aesthetic such as horizontal stripes, vertical stripes, and the like can be rendered following metallization. In this way, a patterned aesthetic can be created wherein the aesthetic reflects a first set of stripes of, for example, 100% reflectivity and a second set of stripes of, for example, 0% reflectivity. Moreover, by masking a portion of the second surface 331, or by similar process any desirable aesthetic can be determined prior to metallization.

In an example of a metallization process, a physical deposition method may be employed. Specifically, the physical deposition method may be a sputter deposition method.

According to an embodiment, following metallization that approximates complete reflectivity, and wherein an approximation of complete metallization is not desirable, an additional step may be required in order to remove metal from the second surface 331, rendering the partially reflecting surface 325 with a controlled reflectivity. In this instance, a method for metal removal may be selected from a group including but not limited to laser ablation and etching The additional step may be applied to the second surface 331 of the optical material 305 in order to control the reflectivity of the metallized surface and produce the partially reflecting surface 325, as directed by an intended visual output to an observer.

The above, generally-described process is described in detail below. To this end, FIG. 3B is a flowchart of a method of metallization of an optical material of a multi-function lighting assembly, according to an exemplary embodiment of the present disclosure. First, a shape of an optical material can be selected S360, wherein the shape of the optical material can be of any cross-sectional shape appropriate for guiding an incident light ray including a cross-sectional shape selected from a group including but not limited to a square, a rectangle, a triangle, and a hexagon. In another embodiment, the shape of the optical material can be selected from a group including biconvex, plano-convex, positive meniscus, negative meniscus, plano-concave, biconcave, and the like. In an example, the selected cross-sectional shape is a rectangle. With the cross-sectional shape for sputter deposition selected, the metal type and length of time for metallization may be selected S361. In selecting the metal type and length of time for metallization, the intended reflectivity of a metallized surface of the optical material can be modulated. For example, increasing the length of time for metallization may increase coverage and/or thickness of a metallization, thereby increasing reflectivity until an approximation of complete reflectivity is achieved. Further, in another example, switching from one metal to another may change the surface roughness of the metallized surface, pursuant to the sputter deposition parameters of the metal, resulting in increased or decreased reflectivity of the metallized surface. In an embodiment, as described above, the surface can be prepared prior to initiation of metallization, via masking, and the like, such that metallization is controlled prior to deposition and a desired aesthetic of the partially reflecting surface is achieved, therefrom. Following initiation and completion of metallization according to the selected parameters S362, an evaluation of the metallized surface of the optical material may be performed S363 in order to determine if metal removal is required S365. In the context of data S364, acquired via methods understood by one of ordinary skill in the art, including contact- and non-contact methodologies, relating to surface roughness, metallization coverage and metallization thickness, a determination of reflectivity and thus, of the necessity for metal removal, may be made. If it is determined that metallization is within the tolerances established, for example, reflectivity between 45% and 55%, surface metallization of the partially reflecting surface is complete S366. Alternatively, if it is determined that the reflectivity of the partially reflecting surface is outside established tolerances, metal removal via an above-described method, for instance. laser ablation, is required S365 and is performed. In an example, metal removal can include spatially trolled removal of metal in order to produce a desired aesthetic of the partially reflecting surface. Upon metal removal via laser ablation, of similar approach, the optical material can be implemented within the multi-function lighting assembly.

In addition to controlling metallization of the partially reflecting surface of the optical material, with reference now to FIG. 4, the orientation and arrangement of the components of a multi-function lighting assembly 400, within a housing of a lighting assembly, can be controlled. In order to ensure that each of a plurality of output light rays is directed along an optical axis 410 of an observer, an angular relationship of each of the components of the multi-function lighting assembly 400 can be adjusted.

According to an embodiment, a first light source 421 emits a first incident light ray 401 and a second light source 422 emits a second incident light ray 402. In an embodiment, an angle 409 between the first incident light ray 401 and the second incident light ray 402 is between 80° and 100°. In an example, the angle 409 between the first incident light ray 401 and the second incident light ray 402 is 90°. Moreover, the angle of incidence of the first incident light ray 401, or angle of first incident light ray 407, formed at a first surface 430 of an optical material 405 by the first incident light ray 401 can be modified based upon a difference between the refractive index of the optical material 405 and the refractive index of an external medium through which the light ray travels. Similarly, the angle of incidence of the second incident light ray 402, or angle of second incident light ray 408, formed at a second surface 431 of the optical material 405 by the second incident light ray 402 can be modified according to a difference between the refractive index of the optical material 405 and the refractive index of an external medium through which the light ray travels. In an example, the medium in which the first incident light ray 401 and the second incident light ray 402 travel is air. In another embodiment, the multi-function lighting assembly 400 can be further modified by adjusting the angular position of the optical material 405. By adjusting an angle 406 formed between the optical material 405 and the optical axis 410, for example, the direction of the plurality of output light rays can be adjusted. In an embodiment, the angle 406 formed between the optical material 405 and the optical axis 410 is between 35° and 55°.In an example, the angle 406 formed between the optical material 405 and the optical axis 410 is 45°. Each of the above-defined relative angles can be adjusted according to system constraints and desired outputs such that the plurality of output light rays from the second surface 431 of the optical material 405 are directed along the optical axis 410 of the observer.

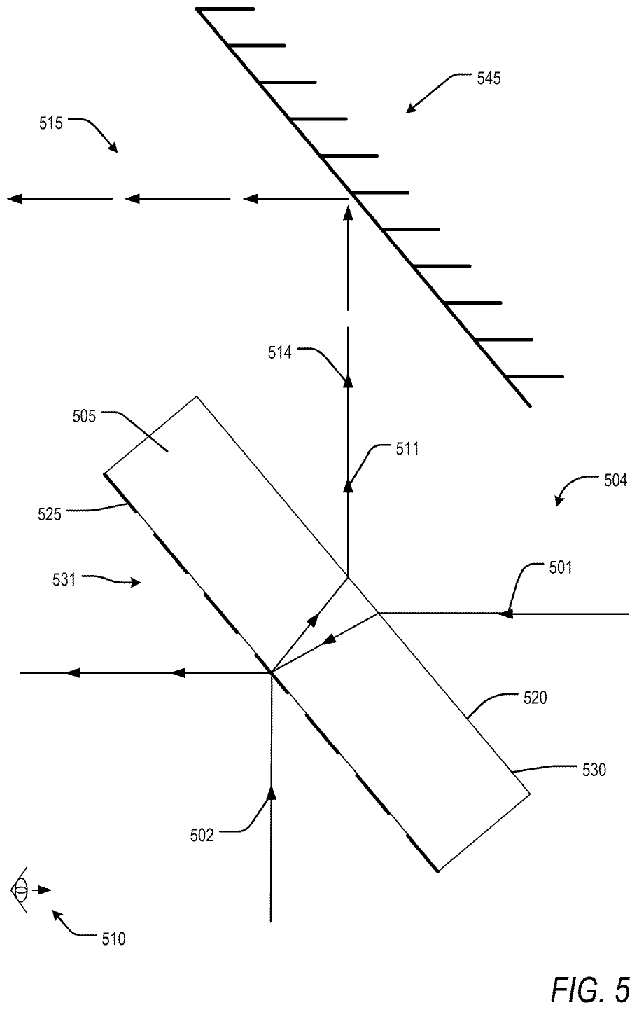

With reference to FIG. 5, it can be appreciated that a first reflected light ray 511, or a portion of a first incident light ray 501, and a second refracted light ray 514, or a portion of a second incident light ray 502, can be lost after refraction through a first surface 530, or refracting surface 530, of an optical material 505. Specifically, a portion of the first incident light ray 501, having refracted through the first surface 530 of the optical material 505 and been reflected by a second surface 531, a partially reflecting surface 531, in an example, of the optical material 505, is again refracted through the first surface 530 of the optical material 505 and directed along a non-optical axis of the observer. Similarly, a portion of the second incident light ray 502, having refracted through the second surface 531 of the optical material 505 and been refracted through the first surface 530 of the optical material 505, is directed along the non-optical axis of the observer.

In order to recover the above-described lost light rays, the multi-function lighting assembly can further comprises a mirror 545 arranged along the non-optical axis of the observer such that the first reflected light ray 511 and the second refracted light ray 514 can be redirected by the mirror 545 and along an optical axis 510 of the observer as one of a plurality of output light rays 515. In an embodiment, the mirror 545 is arranged parallel to an axis of the optical material 505. In another embodiment, the mirror 545 is arranged at an angle relative to the axis of the optical material 505, wherein the angle is determined such that a reflected light ray is delivered along the optical axis 510 of the observer. By including the mirror 545 along the non-optical axis of the observer, efficiency of the multi-function lighting assembly can be improved while increasing light output.

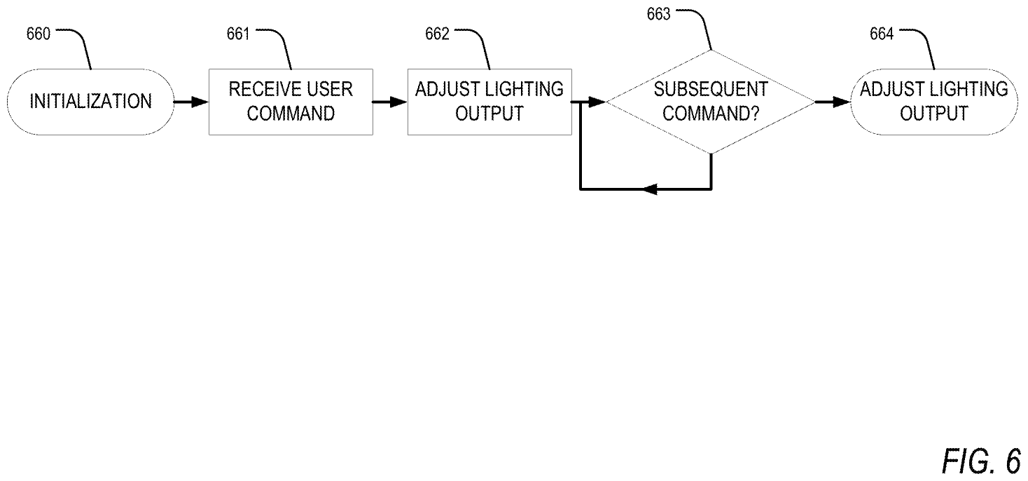

According to an embodiment of the present disclosure, control of a multi-function lighting assembly may be performed by a light control device having a process circuitry. A flowchart of control of the multi-function lighting assembly via the light control device is shown in FIG. 6. In a first step, the light control device is initialization during startup of an automotive vehicle S660. In an embodiment, the light control device is configured to control a multi-function lighting assembly having one or more light sources. In another embodiment, the one or more light sources can be one or more LEDs. In an example, the multi-function lighting assembly includes a white LED of a daytime running light and an amber LED of a turn indicator. In a default state, the light control device controls the multi-function lighting assembly such that the daytime running light is in an active state and the turn indicator is in an inactive state. Upon receiving a user command S661, the light control device can adjust a lighting output S662. Adjusting the lighting output can include changing a luminosity of a plurality of output light rays or can include deactivating the daytime running light, in the default state, and activating the turn indicator. With the turn indicator in an active state, the light control device awaits a subsequent command S663 and maintains the turn indicator in the active state. Following termination of the turning event, the light control device can receive a signal indicating that the daytime running lamp should be activated. As a result, the lighting output is adjusted S664 such that the turn indicator is deactivated and the daytime running light is activated, returning to the default state. In an embodiment, following deactivation of the turn indicator, an automatically-generated command returns the multi-function lighting assembly to the default state.

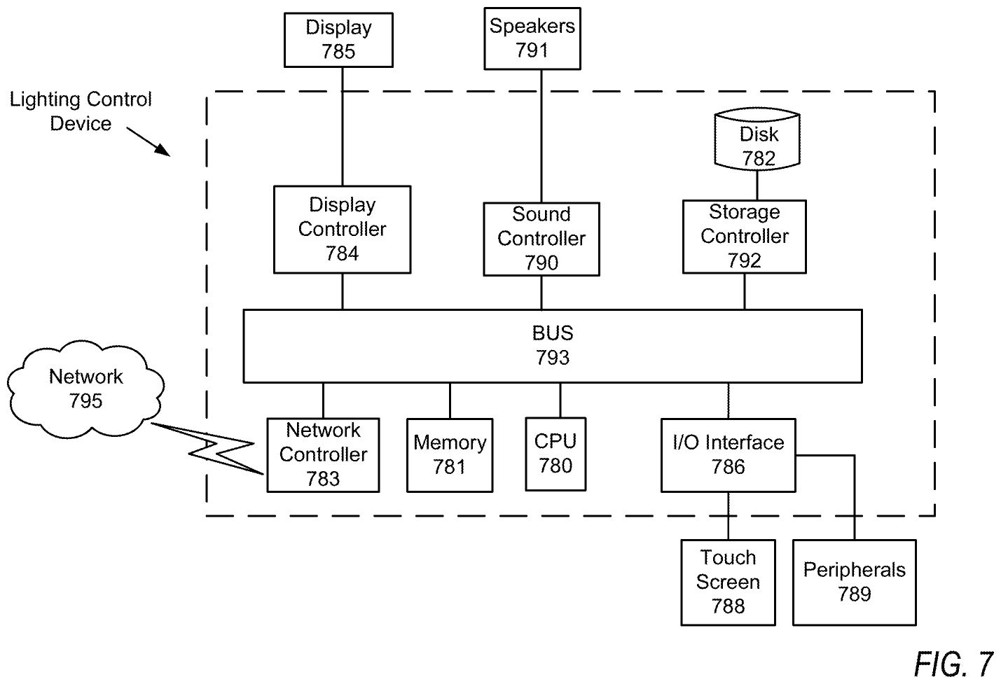

Next, a hardware description of the light control device, according to exemplary embodiments, is described with reference to FIG. 7. In FIG. 7, the light control device includes a CPU 780 which performs the processes described above. The process data and instructions may be stored in memory 781. These processes and instructions may also be stored on a storage medium disk 782 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the light control device communicates, such as a server or computer.

Further, the claimed advancements may be provided as a utility application, background daemon, or component of an operating system, or combination thereof, executing in conjunction with CPU 780 and an operating system such as Microsoft Windows 7, UNIX, Solaris, LINUX, Apple MAC-OS and other systems known to those skilled in the art.

The hardware elements in order to achieve the light control device may be realized by various circuitry elements, known to those skilled in the art. For example, CPU 780 may be a Xenon or Core processor from Intel of America or an Opteron processor from AMD of America, or may be other processor types that would be recognized by one of ordinary skill in the art. Alternatively, the CPU 780 may be implemented on an FPGA, ASIC, PLD or using discrete logic circuits, as one of ordinary skill in the art would recognize. Further, CPU 780 may be implemented as multiple processors cooperatively working in parallel to perform the instructions of the inventive processes described above.

The light control device in FIG. 7 also includes a network controller 783, such as an Intel Ethernet PRO network interface card from Intel Corporation of America, for interfacing with network 795. As can be appreciated, the network 795 can be a public network, such as the Internet, or a private network such as an LAN or WAN network or any combination thereof and can also include PSTN or ISDN sub-networks. The network 795 can also be wired, such as an Ethernet network, or can be wireless such as a cellular network including EDGE, 3G and 4G wireless cellular systems. The wireless network can also be Bluetooth, or any other wireless form of communication that is known.

The light control device further includes a display controller 784, such as a NVIDIA GeForce CTX or Quadro graphics adaptor from NVIDIA Corporation of America for interfacing with display 785, such as a Hewlett Packard HPL2445w LCD monitor. A general purpose I/O interface 786 interfaces with a touch screen panel 788 on or separate from the display 785. General purpose I/O interface also connects to a variety of peripherals. In an example, the light control device is configured to receive tactile commands from a user via the touch screen panel 788.

A sound controller 790 is also provided in the light control device, such as Sound Blaster X-Fi Titanium from Creative, to interface with speakers/microphone 791 thereby providing sounds and/or music. In an example, the light control device is configured to receive verbal commands from a user via the microphone 791.

The general purpose storage controller 792 connects the storage medium disk 782 with communication bus 793, which may be an ISA, EISA, VESA, PCI, or similar, for interconnecting all of the components of the light control device. A description of the general features and functionality of the display 785 as well as the display controller 784, storage controller 792, network controller 783, sound controller 790, and general purpose I/O interface 786 is omitted herein for brevity as these features are known.

Obviously, numerous modifications and variations are possible in light of the above teachings. It is therefore to be understood that within the scope of the appended claims, the invention may be practiced otherwise than as specifically described herein.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. A multi-function light and signal assembly of an automotive vehicle, comprising:
an optical material including a first surface and a second surface that is an at least partially metallized surface, the second surface being planar; and
two or more light sources, wherein
the two or more light sources are arranged such that a first one of the two or more light sources emits a first incident light ray towards the first surface of the optical material and a second one of the two or more light sources emits a second incident light ray towards the second surface of the optical material,
the first incident light ray is refracted through the first surface of the optical material based on an angle of incidence between first incident light ray and the first surface of the optical material, the retracted first incident light ray being directed toward the second surface of the optical material, and
the second incident light ray is refracted through the second surface of the optical material based on a presence of metallization of the at least partially metallized surface and an angle of incidence between the second incident light ray and the second surface of the optical material, the refracted second incident light ray being directed toward the first surface of the optical material.

2. The multi-function light and signal assembly according to claim 1, wherein the first one of the two or more light sources is arranged perpendicularly to the second one of the two or more light sources.

3. The multi-function light and signal assembly according to claim 1, wherein the two or more light sources are light emitting diodes.

4. The multi-function light and signal assembly according to claim 1, wherein the first one of the two or more light sources emits a light of a first color and the second one of the two or more light sources emits a light of a second color.

5. (canceled)

6. (canceled)

7. The multi-function light and signal assembly according to claim 1, wherein a reflectivity of the at least partially metallized surface is controlled by a laser ablation or a is controlled by a masking of a portion of the second surface prior to metallization.

8. The multi-function light and signal assembly according to claim 1, wherein an axis of the optical material forms an angle with an emission of one of the two or more light sources, the angle being a pre-determined angle.

9. The multi-function light and signal assembly according lo claim 1, further comprising a mirror arranged to reflect a portion of light emitted from the two or more light sources, the reflected portion of the emitted light being directed along an optical axis.

10. The multi-function light and signal assembly according to claim 9, wherein an axis of the mirror is parallel to an axis of the optical material.

11. The multi-function light and signal assembly according to claim 1, further comprising a light and signal control device having processing circuitry configured to:
receive an initial command regarding a status of the multi-function light and signal assembly,
deactivate the first one of the two or more light sources,
activate the second one of the two or more light sources,
receive a subsequent command regarding the status of the multi-function light and signal assembly,
deactivate the second one of the two or more light sources, and
activate the first one of the two or more light sources,
wherein the initial command is a user command, and
wherein the subsequent command is a computer-generated command.

12. A multi-function light and signal assembly of an automotive vehicle, comprising:
an optical material including a first surface and a second surface that is an at least partially metallized surface, the second surface being planar;
a mirror; and
two or more light sources, wherein
the two or more light sources are arranged such that a first one of the two or more light sources emits a first incident light ray towards the first surface of the optical material and a second one of the two or more light sources emits a second incident light ray towards the second surface of the optical material,
the first incident light ray is refracted through the first surface of the optical material based on an angle of incidence between the first incident light ray and the first surface of the optical material, the refracted first incident light ray being directed toward the second surface of the optical material,
the second incident light ray is refracted through the second surface of the optical material based on a presence of metallization of the at least partially metallized surface and an angle of incidence between the second incident light ray and the second surface of the optical material, the refracted second incident light ray being directed toward the first surface of the optical material, and
the mirror is arranged to reflect a portion of light emitted from the two or more light sources, the reflected portion of the emitted light being directed along an optical axis of an observer.

13. The multi-function light and signal assembly according to claim 12, wherein the first one of the two or more light sources is arranged perpendicularly to the second one of the two or more light sources.

14. The multi-function light and signal assembly according to claim 12, wherein the two or more light sources are light emitting diodes.

15. The multi-function light and signal assembly according to claim 12, wherein the first one of the two or more light sources emits a light of a first color and the second one of the two or more light sources emits a light of a second color.

16. (canceled)

17. (canceled)

18. The multi-function light and signal assembly according to claim 12,
wherein a reflectivity of the at least partially metallized surface is controlled by a laser ablation or is controlled by a masking of a portion of the second surface prior to metallization.

19. The multi-function light and signal assembly according to claim 12, wherein an axis of the optical material forms an angle with an emission of one of the two or more light sources, the angle being a predetermined angle.

20. The multi-function light and signal assembly according to claim 12, wherein an axis of the mirror is parallel to an axis of the optical material.

21. A multi-function light and signal assembly of an automotive vehicle, comprising:
two or more light sources; and
an optical material including a first surface and a second surface, the second surface being a planar surface and an at least partially metallized surface configured to reflect a portion of light emitted from the two or more light sources, wherein
the two or more light sources are arranged such that a first one of the two or more light sources emits a first incident light ray towards the first surface of the optical material and a second one of the two or more light sources emits a second incident light ray towards the second surface of the optical material,
the first incident light ray is refracted through the first surface of the optical material based on an angle of incidence between the first incident light ray and the first surface of the optical material, the refracted first incident light ray being directed toward the second surface of the optical material, a first portion of the refracted first incident light ray being reflected by the at least partially metallized surface,
a first portion of the second incident light ray is refracted through the second surface of the optical material based on an angle of incidence between the second incident light ray and the second surface of the optical material, the refracted second incident light ray being directed toward the first surface of the optical material,
a second portion of the second incident light ray is reflected by the at least partially metallized surface along a visual axis of an observer, and
a second portion of the refracted first incident light ray is refracted through the second surface of the optical material along the visual axis of the observer.

22. The multi-function light and signal assembly according to claim 21, further comprising a light and signal control device having processing circuitry configured to
receive an initial command regarding a status of the multi-function light and signal assembly,
deactivate the first one of the two or more light sources,
activate the second one of the two or more light sources,
receive a subsequent command regarding the status of the multi-function light and signal assembly,
deactivate the second one of the two or more light sources, and
activate the first one of the two or more light sources.
